(19) United States
(12) Patent Application Publication
(10) Pub. No.: US 2019/0045393 A1
(43) Pub. Date: Feb. 7, 2019

(54) Fragmented Data Transmission

(71) Applicant: T-Mobile USA, Inc., Bellevue, WA (US)

(72) Inventors: Yasmin Karimli, Kirkland, WA (US); Puja Gupta, Redmond, WA (US); Karri Mikael Kuoppamaki, Redmond, WA (US)

(73) Assignee: T-Mobile USA, Inc.

(21) Appl. No.: 15/838,204

(22) Filed: Dec. 11, 2017

Related U.S. Application Data
(60) Provisional application No. 62/541,556, filed on Aug. 4, 2017.

(51) Int. Cl. H04W 28/06; H04L 29/08; H04L 29/06

(52) U.S. Cl. CPC H04W 28/06; H04L 69/22; H04L 67/06

(57) ABSTRACT

Fragmented data transmission is described. In an example, server(s) can access a file associated with content to be transmitted to a device of a user. The server(s) can partition the file into a plurality of fragments and, responsive to determining that an available amount of bandwidth associated with a data transmission via a network is greater than or equal to a first size of a fragment of the plurality of fragments, the server(s) can send, via the network, at least the fragment of the plurality of fragments to the device operated by a user. In some examples, the data transmission can be a real-time data transmission. At one or more other times, the server(s) can send, via the network, other fragments of the plurality of fragments to the device. After the device receives each fragment of the plurality of fragments, the device can make the content available for consumption.

### PRIORITY APPLICATION

This application claims the benefit of U.S. Provisional Application No. 62/541,556, filed on Aug. 4, 2017, the entire contents of which are incorporated herein by reference.

### BACKGROUND

As content consumers continue to use mobile devices for accessing content, networks facilitating the transmission of such content can become crowded and slow. Large file downloads consume critical bandwidth resources and can be inefficient. To conserve resources, large file downloads can be sent during off-peak hours or via Wi-Fi. Accordingly, content consumers can be forced to wait to receive the content associated with the large file downloads and/or can become frustrated with the user experience.

### BRIEF DESCRIPTION OF THE DRAWINGS

The detailed description is set forth with reference to the accompanying figures. In the figures, the left-most digit(s) of a reference number identifies the figure in which the reference number first appears. The use of the same reference numbers in different figures indicates similar or identical items or features.

FIG. 1 illustrates techniques for transmitting fragmented data from a service provider to a device.

FIG. 2 illustrates a system for facilitating fragmented data transmission.

FIG. 3 illustrates an example process for transmitting fragmented data from a service provider to a device.

FIG. 4 illustrates an example process for tracking progress of a fragmented data transmission.

FIG. 5 illustrates an example process for receiving fragmented data and assembling the fragmented data for making content available for consumption.

### DETAILED DESCRIPTION

This disclosure describes fragmented data transmission. As described above, as content consumers continue to use mobile devices for accessing content, networks facilitating the transmission of such content can become crowded and slow. Large file downloads consume critical bandwidth resources and can be inefficient. To conserve resources, large file downloads can be sent during off-peak hours or via Wi-Fi. Accordingly, content consumers can be forced to wait to receive the content associated with the large file downloads and can become frustrated with the user experience.

In some examples, content requested by a consumer can be requested for immediate consumption. For instance, a consumer can request content from websites, social media applications, photo downloads, etc. and such content can be provided via near-real-time data transmissions. In other examples, content may not be requested for immediate consumption, but for consumption at a future time (e.g., delayed consumption). For instance, a consumer can request an e-book from a public library, which can be provided to the consumer at a future time. Or, a consumer can request a television show to be stored on his or her digital video recorder (DVR) for viewing at a future time. Techniques described herein are directed to improving user experience by optimizing data transmissions of content that is not requested for immediate consumption (e.g., delayed consumption content). For instance, in at least one example, techniques described herein can utilize unused bandwidth associated with real-time data transmission(s) to transmit fragment(s) of delayed consumption content to a device of a user. That is, techniques described herein can enable the transmission of fragment(s) anytime there is unused bandwidth associated with a network, and all of the fragment(s) do not need to be transmitted at the same time. For instance, in some examples, a fragment can be transmitted in the morning and another fragment transmitted later in the day. The device of the user can store the fragments of the delayed consumption content until all fragments have been received and can reassemble the fragments for making the content available to the consumer. That is, the device can store the fragments and reconstruct the content prior to making the content available to the consumer.

In at least one example, server(s) associated with a service provider can partition a data file associated with content into a plurality of fragments. Each fragment can be associated with a particular number of bits (or bytes). The server(s) can analyze bandwidth associated with a network to determine when the bandwidth available is sufficient to transmit a fragment of a data file. For instance, the server(s) can determine whether the bit-rate of available information capacity associated with a particular data transmission over the network is greater than or equal to the size of one or more of the fragments of the data file. Responsive to determining that the available bandwidth is greater than or equal to the size of one or more of the fragments of the data file, the server(s) can transmit one or more of the fragments of the data file via the network. That is, techniques described herein are directed to leveraging unused bandwidth of a network to transmit fragments of a data file to a device when such bandwidth is available, such that when all fragments of the data file have been transmitted to the device, the content associated with the data file is available for consumption by the consumer.

In at least one example, one or more fragments of the data file can be transmitted in association with a real-time data transmission. That is, in at least one example, a real-time data transmission may not consume all of the bandwidth available for the transmission and the server(s) can determine to transmit at least one fragment of the data file with the real-time data transmission. In at least one example, the server(s) can transmit individual of the plurality of fragments of the data file at different times. In some examples, the plurality of fragments of the data file can be transmitted in chronological order (e.g., consistent with the order in which the content is to be presented). In other examples, the plurality of fragments may not be transmitted in chronological order (e.g., in an order that optimizes the time required to transmit the entire data file to the device). As described above, in some examples, one or more fragments can be transmitted at a same time. Or, in other examples, fragments can be transmitted one at a time. As described above, techniques described herein enable the transmission of individual fragments of a data file when network bandwidth is available, and individual fragments can be transmitted at different times of a day (e.g., morning, afternoon, evening), on different days, etc. That is, unlike existing techniques, the fragments do not need to be sent at one time and/or downloaded at one time.

As a non-limiting example, a user can request, via a device, an e-book from an online library. The user can indicate that the e-book is not for immediate consumption. The device can send a request for the e-book to a service provider. Server(s) associated with the service provider can access a data file associated with the e-book from a content database and/or one or more computing devices associated with the library. The server(s) can partition the data file into fragments. As network bandwidth becomes available, the server(s) can transmit individual fragments from the server(s) to the device. In some examples, individual of the fragments can be transmitted to the device in association with real-time data transmissions. When all of the fragments have been transmitted to the device, the device can reassemble the fragments into the complete data file and can make the e-book available to the user via the device. That is, the device can reconstruct the data file associated with the e-book before making the e-book available via the device.

As described above, techniques described herein are directed to leveraging unused bandwidth of a network to transmit fragments of a data file to a device when such bandwidth is available, such that when all fragments of the data file have been transmitted to the device, the content associated with the data file is available for consumption by the consumer. In some examples, when different consumers request the same content, individual fragments can be transmitted to respective devices in different orders and/or at different times. That is, the timing and arrangement of the transmission of fragments of a data file can depend on unallocated bandwidth associated with data transmissions to the respective devices.

In the non-limiting example above, a different user can request the same e-book from the online library. As network bandwidth becomes available, the server(s) can transmit individual fragments from the server(s) to a device associated with the different user. In some examples, individual of the fragments can be transmitted to the device in association with real-time data transmissions. Accordingly, individual of the fragments can be transmitted at different times and/or in a different order than the fragments that are transmitted to the user described above. When all of the fragments have been transmitted to the device operated by the different user, the device can reassemble the fragments into the complete data file and can make the e-book available to the different user via the device. That is, the device can reconstruct the data file associated with the e-book before making the e-book available to the different user via the device. In such an example, the content can be the same, but the means by which the fragments are delivered to the device of the different user can be different, as determined by data transmissions to the device operated by the different user.

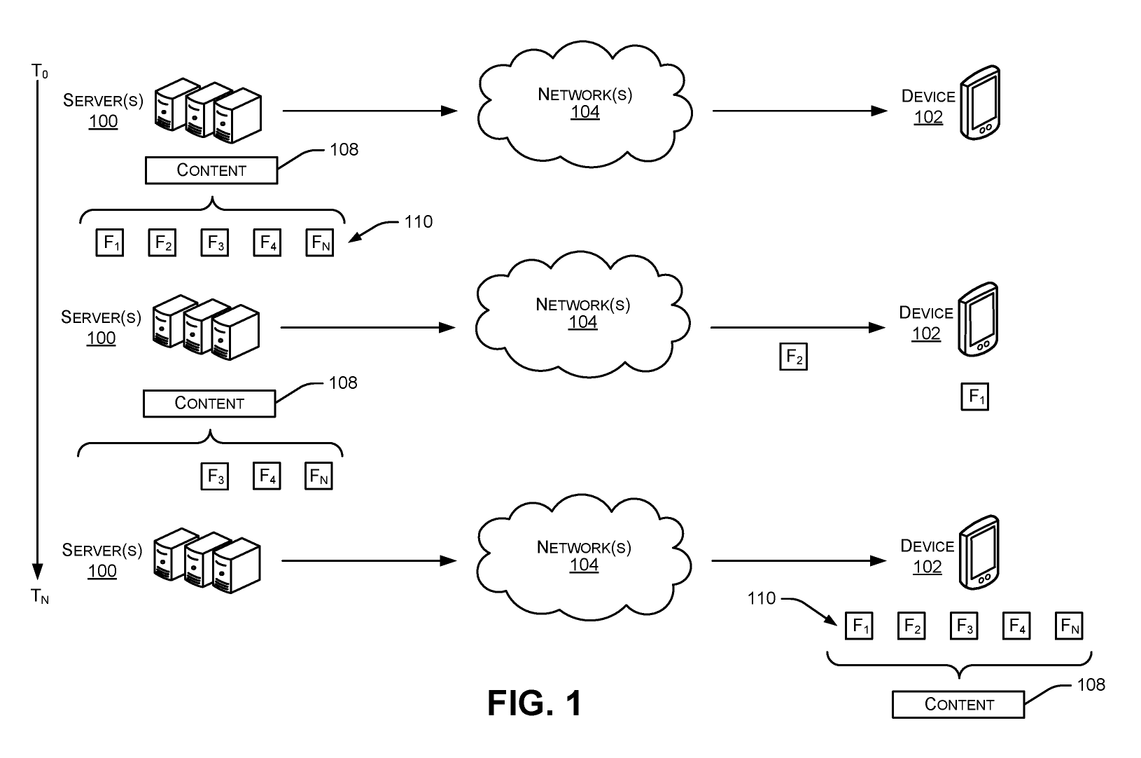

FIG. 1 illustrates techniques for transmitting fragmented data from a service provider to a device. In at least one example, server(s) 100 associated with a service provider can communicate with one or more devices, such as device 102, via one or more networks 104. The server(s) 100 can be any type of server, such as a network-accessible server. In some examples, the server(s) 100 can be stand-alone computing systems, distributed-computing systems, networked-computing systems, etc. For instance, in at least one example, one or more of the functionalities described herein as being performed by the server(s) 100 can be performed by a single device or multiple devices, which may be distributed in one or more locations. In at least one example, the device 102 can correspond to user equipment (UE) including, but not limited to, a smart phone, a personal digital assistant, a netbook, a laptop computer, a smart appliance, and/or another electronic device that is capable of transmitting or receiving audio, video, and/or data via the network(s) 104. The network(s) 104 can include cellular network(s), Wi-Fi network(s), the Internet, or other network(s).

In at least one example, the server(s) 100 can access a data file 108 associated with content. In some examples, the content can be requested by a user (not pictured) of the device 102. In other examples, the content may not be requested by the user. In some examples, a data file associated with the content can be stored in a database associated with the server(s) 100. In other examples, a data file associated with the content can be stored remotely and can be accessible to the server(s) 100 (e.g., data files can be stored in association with other sources and/or systems).

The server(s) 100 can partition the data file 108 into smaller fragments 110 (e.g., F₁-F_{N}). As described above, each fragment can be associated with a size, which can be defined by a number of bits (or bytes). Fragments can have the same size or different sizes. That is, in some examples, all fragments can be associated with a same size and in other examples, fragments can be associated with different sizes.

In at least one example, the server(s) 100 can append metadata to individual fragments. For instance, the server(s) 100 can append a header that indicates that the fragment is a portion of a larger data file (which can signal that additional fragments are to be expected). In some examples, the header can indicate a position of a fragment relative to the complete data file 108. For instance, the header can indicate that a fragment is a beginning portion of the data file 108 or an ending portion of the data file 108. In some examples, the header can indicate a position of a fragment relative to other fragments (e.g., a packet number). For instance, the header can indicate that F₂ precedes F₃, which precedes F₄, and so on. In some examples, the header can indicate a characteristic associated with the fragment. For instance, the header can indicate whether content associated with the data file 108 is mandatory, optional, urgent, etc. Furthermore, the header can indicate a source of the data file 108, an intended recipient of the fragment, etc.

The server(s) 100 can assess bandwidth associated with the network(s) 104. That is, the server(s) 100 can determine a bit-rate of available information capacity associated with the network (s) 104. In some examples, the server(s) 100 can determine how much bandwidth to allocate to a particular data transmission (which can be defined by resource block(s)). In such examples, the server(s) 100 can analyze a location of a requesting device, a time associated with a request, data consumption associated with the device, etc. to determine how much bandwidth (e.g., how many resource blocks) to allocate to the particular data transmission.

In at least one example, the server(s) 100 can determine whether any bandwidth is unallocated for transmitting particular data transmissions. For instance, the server(s) 100 can determine whether an amount of bandwidth allocated for a particular data transmission is completely consumed by that data transmission, or if any of the bandwidth is unallocated. In at least one example, the server(s) 100 can determine whether an amount of unallocated bandwidth is greater than or equal to the size of one or more of the fragments 110. Responsive to determining that bandwidth is available and that the available bandwidth is greater than or equal to the size of one or more of the fragments 110 of the data file 108, the server(s) 100 can transmit one or more of the fragments 110 of the data file 108 via the network(s) 104. That is, responsive to determining that bandwidth is available and that the available bandwidth is greater than or equal to the size of one or more of the fragments 110 of the data file 108, the server(s) 100 can transmit one or more of the fragments 110 with a total size that is less than or equal to the amount of bandwidth that is available.

As illustrated in FIG. 1, a first fragment F₁ has been transmitted to the device 102. At a subsequent time, the server(s) 100 can determine that the available bandwidth associated with the network(s) 104 is greater than or equal to the size of a second fragment F₂. Accordingly, the server(s) 100 can transmit the second fragment F₂ to the device 102, as illustrated in FIG. 1. In at least one example, as described herein, the first fragment F₁ and the second fragment F₂ can each be transmitted in association with other data transmissions (e.g., a real-time data transmission). Over time, each of the fragments 110 can be transmitted from the server(s) 100 to the device 102. After each of the fragments 110 is transmitted to the device 102, the device 102 can assemble the fragments 110 to generate the data file 108 on the device 102. After the data file 108 has been generated, the device 102 can make the associated content available for the user via the device 102.

That is, as illustrated in FIG. 1, techniques described herein are directed to leveraging unused bandwidth, for instance associated with individual data transmissions, to transmit individual fragments of the data file 108 to the device 102 when such bandwidth is available, such that when all fragments of the data file 108 have been transmitted to the device 102, the content associated with the data file 108 is available for consumption by a consumer (e.g., the user). As a result, data files associated with content that is to be consumed at a future time (instead of immediately) can be transmitted to devices over time, reducing the impact of such transmissions on the network(s) 104 and making such downloads more efficient. That is, techniques described herein (and illustrated in FIG. 1) enable more efficient data transmission by optimizing available bandwidth resources for use with fragmented data transmission.

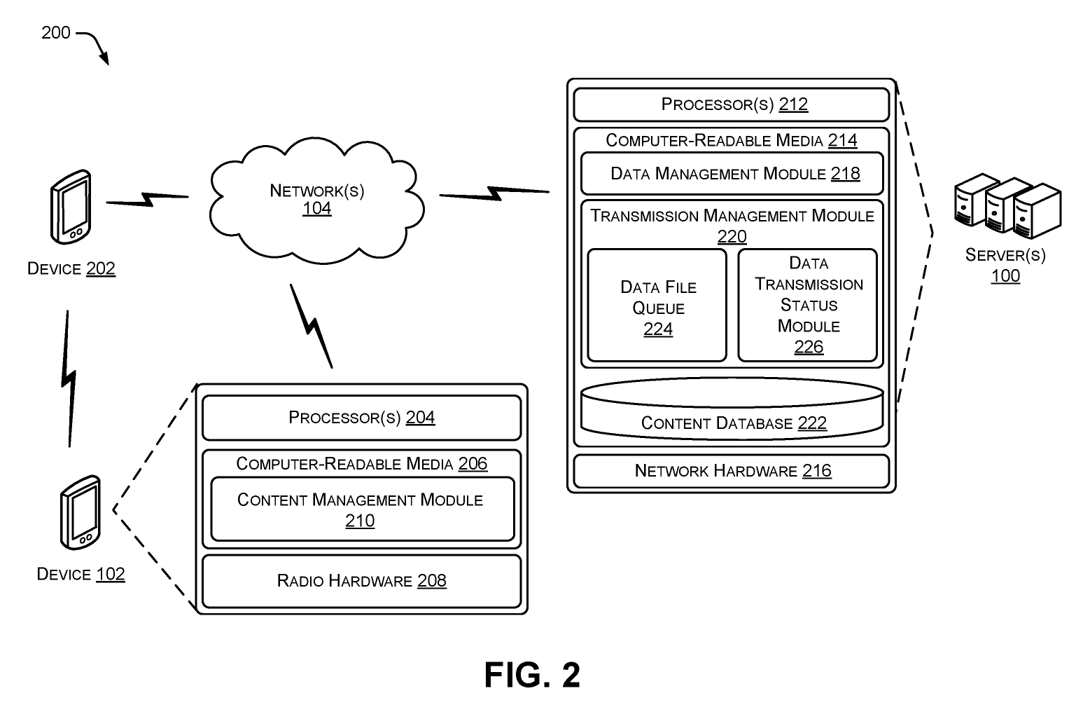

FIG. 2 illustrates a system 200 for facilitating fragmented data transmission. The system 200 can include the server(s) 100, the device 102, and the network(s) 104, as described above with respect to FIG. 1. FIG. 2 additionally includes a second device 202, that has a same or similar structure and/or can perform the same or similar functions as the device 102.

In at least one example, the device 102 can include processor(s) 204, computer-readable media 206, and radio hardware 208. The processor(s) 204 can represent, for example, a central processing unit (CPU)-type processing unit, a graphics processing unit (GPU)-type processing unit, a Field-Programmable Gate Array (FPGA), another class of Digital Signal Processor (DSP), or other hardware logic components that can, in some instances, be driven by a CPU. For example, and without limitation, illustrative types of hardware logic components that can be used include Application-Specific Integrated Circuits (ASICs), Application-Specific Standard Products (ASSPs), System-on-a-Chip Systems (SOCs), Complex Programmable Logic Devices (CPLDs), etc. In at least one example, an accelerator can represent a hybrid device, such as one from ZYLEX or ALTERA that includes a CPU course embedded in an FPGA fabric. In various embodiments, the processor(s) 204 can execute one or more modules and/or processes to cause the device 102 to perform a variety of functionalities, as set forth above and explained in further detail in the following disclosure. Additionally, each of the processor(s) 204 can possess its own local memory, which also can store program modules, program data, and/or one or more operating systems.

Depending on the exact configuration and type of the device 102, the computer-readable media 206, can include computer storage media and/or communication media.

Computer storage media can include volatile memory, nonvolatile memory, and/or other persistent and/or auxiliary computer storage media, removable and non-removable computer storage media implemented in any method or technology for storage of information such as computer readable instructions, data structures, program modules, or other data. Computer memory is an example of computer storage media. Thus, computer storage media includes tangible and/or physical forms of media included in a device and/or hardware component that is part of a device or external to a device, including but not limited to random-access memory (RAM), static random-access memory (SRAM), dynamic random-access memory (DRAM), phase change memory (PRAM), read-only memory (ROM), erasable programmable read-only memory (EPROM), electrically erasable programmable read-only memory (EEPROM), flash memory, compact disc read-only memory (CD-ROM), digital versatile disks (DVDs), optical cards or other optical storage media, miniature hard drives, memory cards, magnetic cassettes, magnetic tape, magnetic disk storage, magnetic cards or other magnetic storage devices or media, solid-state memory devices, storage arrays, network attached storage, storage area networks, hosted computer storage or any other storage memory, storage device, and/or storage medium that can be used to store and maintain information for access by a computing device.

In at least one example, the computer storage media can include non-transitory computer-readable media. Non-transitory computer-readable media can include volatile and nonvolatile, removable and non-removable tangible, physical media implemented in technology for storage of information, such as computer readable instructions, data structures, program modules, or other data. The computer-readable media 206 is an example of non-transitory computer-readable media. Non-transitory computer-readable media include, but are not limited to, RAM, ROM, EEPROM, flash memory or other memory technology, CD-ROM, DVDs or other optical storage, magnetic cassettes, magnetic tape, magnetic disk storage or other magnetic storage devices, or any other tangible, physical medium which can be used to store the desired information and which can be accessed by the device 102. Any such non-transitory computer-readable media can be part of the device 102.

In contrast, communication media includes computer readable instructions, data structures, program modules, or other data in a modulated data signal, such as a carrier wave, or other transmission mechanism. As defined herein, computer storage media does not include communication media.

The computer-readable media 206 can include one or more modules and data structures including, for example, a content management module 210. The one or more modules and data structures can be in the form of stand-alone applications, productivity applications, an operating system component, or any other application or software module configured to facilitate content management, as described herein.

The content management module 210 can manage content for the device 102. In at least one example, the content manager 210 can send a request for content (e.g., responsive to user input) to the server(s) 100. In some examples, the content can be for immediate consumption. In other examples, the content can be for delayed consumption (e.g., consumption at a time in the future). In at least one example, responsive to sending the request for content, the content management module 210 can receive fragments of a data file associated with the requested content. In alternative examples, the content management module 210 can receive fragments of a data file without having first sent a request (e.g., content can be pushed to the device 102). As described above, the fragments can be received in chronological order, or in another order that is not chronological. In at least one example, responsive to receiving a fragment, the content management module 210 can send an acknowledgement notification to notify the sever(s) 100 that the fragment was received.

In at least one example, a fragment can be associated with metadata (e.g., a header) that indicates that the fragment is a portion of a larger data file (which can signal that additional fragments are to be expected). In some examples, the header can indicate a position of a fragment relative to a complete data file. For instance, the header can indicate that a fragment is a beginning portion of the data file or an ending portion of the data file. In some examples, the header can indicate a position of a fragment relative to other fragments (e.g., a packet number). In some examples, the header can indicate a characteristic associated with the fragment. For instance, the header can indicate whether content associated with the data file 108 is mandatory, optional, urgent, etc. Furthermore, the header can indicate a source of the data file 108, an intended recipient of the fragment, etc.

In at least one example, the content management module 210 can analyze the fragment and associated metadata to determine whether to make content associated with the fragment available upon receipt, or to refrain from making the content available until additional fragments are received. That is, the content management module 210 can analyze the fragment and based on determining a presence of a header indicating that the fragment is a portion of a larger data file, the content management module 210 can determine to refrain from making the content associated with the fragment available until additional fragments are received. In at least one example, the content management module 210 can determine to refrain from making the content associated with the fragment available until a fragment associated with metadata indicating that it is the last fragment is received or otherwise determining that the complete data file has been transferred.

A transmission can fail for various reasons. In at least one example, the content management module 210 can utilize a timer to track time. Based on determining the lapse of a predetermined amount of time after the receipt of a fragment without receiving another fragment, the content management module 210 can send a request to the server(s) 100 to re-transmit a subsequent fragment. Similarly, based on determining the lapse of a predetermined amount of time after receipt of a first fragment without completing the download of the data file (e.g., the data transmission timed out), the content management module 210 can send a notification to the server(s) 100 to indicate that the transmission failed and/or to request re-transmission of the data file.

After determining that all fragments associated with a data file have been received, the content management module 210 can assemble (e.g., reassemble) the multiple fragments to generate the complete data file at the device 102. That is, the content management module 210 can reconstruct the data file after all fragments associated with the data file have been received by the device 102. After the data file is assembled on the device 102, the content management module 210 can make the content associated with the data file available to the user.

In at least one example, the device 102 can share fragments and/or complete data files with other devices, such as device 202, via peer-to-peer communication. Peer-to-peer communication enables two or more devices to communicate directly without communicating with server(s) or another central node. Accordingly, the device 102 can transmit fragments and/or the complete data file to the device 202 without involving the server(s) 100. As a result, a user operating the device 202 can consume the same content as a user operating the device 102.

The radio hardware 208 provides wireless UE capabilities, such as connecting to a base station associated with the network(s) 104. The radio hardware 208 can include or be incorporated into processors, ASICs, programmable circuits such as FPGAs, or in other ways.

As described above, the server(s) 100 can be stand-alone computing systems, distributed-computing systems, networked-computing systems, etc. For instance, in at least one example, one or more of the functionalities described herein as being performed by the server(s) 100 can be performed by a single device or multiple devices, which may be distributed in one or more locations. For instance, in at least one example, one or more of functions described below with respect to the server(s) 100 can be performed by centrally located server(s) or another element of a network architecture (e.g., E-UTRAN Node B, etc.). In various examples, each of the server(s) 100 can be associated with one or more processors 212, computer-readable media 214, and network hardware 216. The processor(s) 212 can have the same and/or similar structure and/or function as the processor(s) 204, described above.

Depending on the exact configuration and type of the server(s) 100, the computer-readable media 214 can include computer storage media and/or communication media. The computer-readable media 214 can have the same and/or similar structure and/or function as the computer-readable media 206, described above. The computer-readable media 214 can include one or more modules and data structures including, for example, a data management module 218, a transmission management module 220, and a content database 222. The one or more modules and data structures can be in the form of stand-alone applications, productivity applications, an operating system component, or any other application or software module for facilitating intelligent network routing, as described herein.

In at least one example, the data management module 218 can receive request(s) for content and can access data file(s) associated with the content responsive to receiving such request(s). In other examples, the data management module 218 can access content without first receiving a request. In some examples, the data management module 218 can access data file(s) associated with content from a content database 222. In other examples, the data management module 218 can access data file(s) associated with content from other sources or systems.

In at least one example, the data management module 218 can retrieve the data file and can partition the data file into a plurality of fragments. As described above, each fragment can be associated with a size, which can be defined by a number of bits (or bytes). Fragments can have the same size or different sizes. That is, in some examples, all fragments are associated with a same size and in other examples, fragments can be associated with different sizes.

In at least one example, the data management module 218 can append metadata to individual fragments. For instance, the data management module 218 can append a header that indicates that the fragment is a portion of a larger data file (which can signal that additional fragments are to be expected). In some examples, the header can indicate a position of a fragment relative to the complete data file. For instance, the header can indicate that a fragment is a beginning portion of the data file or an ending portion of the data file. In some examples, the header can indicate a position of a fragment relative to other fragments (e.g., a packet number). In some examples, the header can indicate a characteristic associated with the fragment. For instance, the header can indicate whether content associated with the data file 108 is mandatory, optional, urgent, etc. Furthermore, the header can indicate a source of the data file 108, an intended recipient of the fragment, etc.

The transmission management module 220 can facilitate the transmission of data file(s) from the server(s) 100 to requesting device(s), like the device 102. In at least one example, the transmission management module 220 can include a data file queue 224 and a data transmission status module 226.

In at least one example, the transmission management module 220 can add indications of data file(s) corresponding to particular content to the data file queue 224. For instance, responsive to receiving a request for content, the transmission management module 220 can add an indication of a data file corresponding to the content (as provided by the data management module 218), and an intended recipient (e.g., an identifier of a device that requested and/or is to receive the data file), to the data file queue 224. Or, in some examples, the transmission management module 220 can add an indication of a data file corresponding to the content (as provided by the data management module 218) to the data file queue 224 without first receiving a request.

As described above, the transmission management module 220 can assess bandwidth associated with the network(s) 104. In some examples, the transmission management module 220 can determine how much bandwidth to allocate to a particular data transmission (which can be defined by resource block(s)). In such examples, the transmission management module 220 can analyze a location of a requesting device, a time associated with a request, data consumption associated with the device, etc. to determine how much bandwidth (e.g., how many resource block(s)) to allocate to the particular data transmission.

In at least one example, the transmission management module 220 can determine whether any bandwidth is unallocated for transmitting particular data transmissions. For instance, the transmission management module 220 can determine whether an amount of bandwidth allocated for a particular data transmission is completely consumed by that data transmission, or if any of the bandwidth is unallocated. In at least one example, the transmission management module 220 can determine whether an amount of unallocated bandwidth is greater than or equal to the size of one or more of the fragments such to facilitate the transmission of one or more fragments associated with data file(s) in the data file queue 224. Responsive to determining that bandwidth is available and that the available bandwidth is greater than or equal to the size of one or more of the fragments of the data file(s) in the data file queue 224, the transmission management module 220 can transmit one or more of the fragments via the network(s) 104, in association with the particular data transmission. That is, the transmission management module 220 can select one or more fragments having a total size that is less than the amount of bandwidth available and can transmit the one or more fragments via the network(s) 104, in association with the particular data transmission.

In at least one example, the transmission management module 220 can utilize metadata associated with headers of the fragments to determine which fragment(s) to send and when to send them. For instance, in at least one example, the transmission management module 220 can utilize metadata associated with headers of the fragments to prioritize which fragments to transmit and when to transmit such fragments. As an example, if a header indicates that a corresponding fragment is mandatory, the transmission management module 220 can transmit such a fragment prior to a fragment having a header that indicates that it is optional. In additional and/or alternative examples, in at least one example, the transmission management module 220 can utilize metadata associated with headers of the fragments to determine how to group fragments for transmission. For instance, in some examples, fragments associated with different data files can be transmitted together. As an example, the transmission management module 220 can group fragments together (from the same or different data files) for transmitting to a device so long as the fragments are being transmitted to the same recipient (e.g., the same requesting device, etc.).

In at least one example, the data transmission status module 226 can track the progress of individual data transmissions. In at least one example, responsive to determining that the transmission management module 220 has sent at least one fragment of a data file in the data file queue 224, the data transmission status module 226 can remove the indicator of the data file from the data file queue 224 and can begin tracking the progress of the transmission of the data file. In at least one example, the data transmission status module 226 can indicate that transmission of the data file is in progress. As devices receive the fragments, the devices can send acknowledgement notifications back to the server(s) 100. Responsive to receiving an acknowledgement notification, the data transmission status module 226 can update the status of the transmission of the data file. Based at least in part on determining that each fragment of a data file has been successfully transmitted to the intended recipient device, the data transmission status module 226 can update the status of the transmission of the data file to indicate that the transmission is complete.

In some examples, the transmission management module 220 can send a fragment and the data transmission status module 226 can track an amount of time that lapses before an acknowledgement notification is received. Based at least in part on determining the lapse of a predetermined amount of time without receiving an acknowledgment notification, the data transmission status module 226 can determine that the transmission failed and can instruct the transmission management module 220 to re-send the fragment. In an additional and/or alternative example, the data transmission status module 226 can receive a request (e.g., from the device 102) to re-transmit a particular fragment or one or more particular fragments, and can instruct the transmission management module 220 to re-send the particular fragment responsive to receiving such a request. In such examples, the data transmission status module 226 can indicate that the transmission of the data file is incomplete and that the transmission management module 220 is re-transmitting at least a portion of the data file.

The content database 222 can store data files associated with content. In some examples, the data files associated with the content can be originated by the service provider or can be received from other sources and/or systems and stored in the content database 222. In alternative examples, data files associated with content can be stored remotely and can be accessible to the server(s) 100 (e.g., data files can be stored in association with other sources and/or systems).

The network hardware 216 can provide wired or wireless networking capabilities to the server(s) 100. The network hardware 216 can include or be incorporated into processors, ASICs, programmable circuits such as FPGAs, or in other ways.

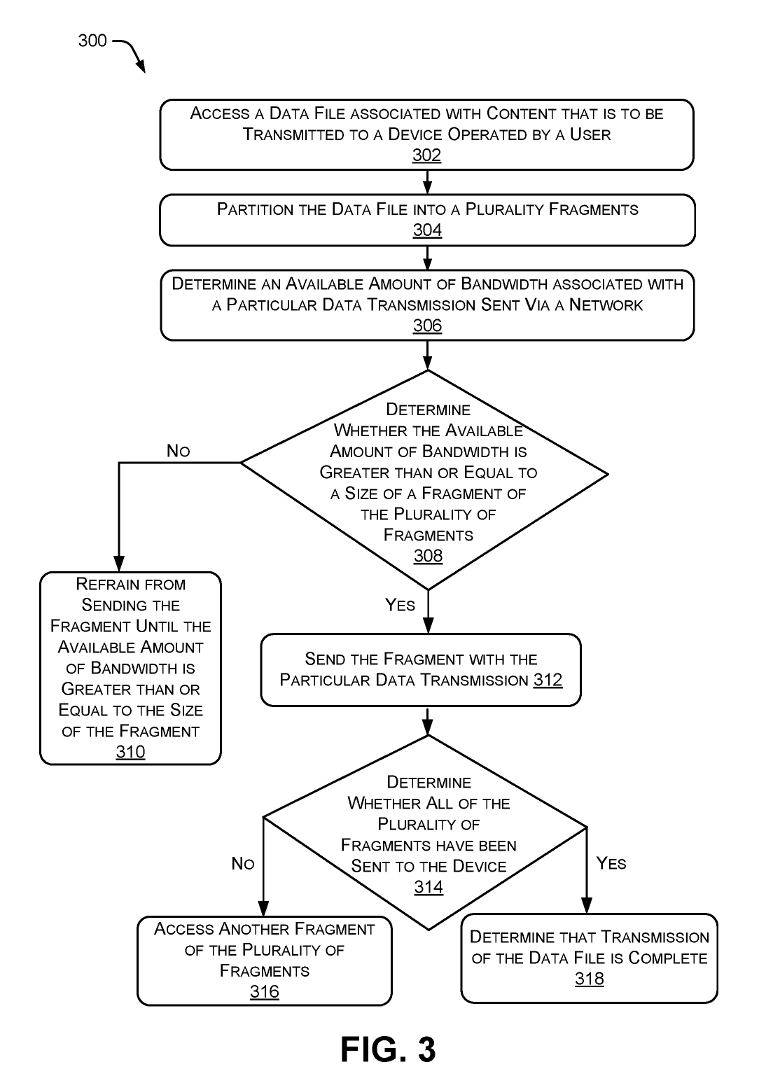

FIGS. 3-5 describe example processes for fragmented data transmission. The example processes are described in the context of the environments of FIGS. 1 and 2, but are not limited to those environments.

The processes described above in association with FIGS. 3-5 can be implemented in hardware, software, or a combination thereof. In the context of software, the operations represent computer-executable instructions stored on one or more computer-readable storage media that, when executed by one or more processors, perform the recited operations. Generally, computer-executable instructions include routines, programs, objects, components, data structures, and the like that perform particular functionalities or implement particular abstract data types. In other embodiments, hardware components perform one or more of the operations. Such hardware components can include or be incorporated into processors, ASICs, programmable circuits such as FPGAs, or in other ways. The order in which the operations are described is not intended to be construed as a limitation, and any number of the described operations and/or processes can be combined in any order and/or in parallel to implement the processes.

FIG. 3 illustrates an example process 300 for transmitting fragmented data from a service provider to a device.

Block 302 illustrates accessing a data file associated with content that is to be transmitted to a device operated by a user. As described above, the data management module 218 can access data file(s) associated with content. In at least one example, the data management module 218 can receive a request for content and can access a data file associated with the content responsive to receiving the request. In other examples, the data management module 218 can access content without first receiving a request. In some examples, the data management module 218 can access the data file from a content database 222. In other examples, the data management module 218 can access the data file from other sources or systems.

In at least one example, the transmission management module 220 can add indications of the data file corresponding to the requested content to the data file queue 224. For instance, responsive to receiving a request for content, the transmission management module 220 can add an indication of a data file corresponding to the content (as provided by the data management module 218), and an intended recipient (e.g., an identifier of a device that requested and/or is to receive the data file), to the data file queue 224. Or, in some examples, the transmission management module 220 can add an indication of a data file corresponding to the content (as provided by the data management module 218) to the data file queue 224 without first receiving a request.

Block 304 illustrates partitioning the data file into a plurality of fragments. In at least one example, the data management module 218 can retrieve the data file and can partition the data file into a plurality of fragments. As described above, each fragment can be associated with a size, which can be defined by a number of bits (or bytes). Fragments can have the same size or different sizes. That is, in some examples, all fragments are associated with a same size and in other examples, fragments can be associated with different sizes.

In at least one example, the data management module 218 can append metadata to individual fragments. For instance, the data management module 218 can append a header that indicates that the fragment is a portion of a larger data file (which can signal that additional fragments are to be expected). In some examples, the header can indicate a position of a fragment relative to the complete data file. For instance, the header can indicate that a fragment is a beginning portion of the data file or an ending portion of the data file. In some examples, the header can indicate a position of a fragment relative to other fragments (e.g., a packet number). In some examples, the header can indicate a characteristic associated with the fragment. For instance, the header can indicate whether content associated with the data file 108 is mandatory, optional, urgent, etc. Furthermore, the header can indicate a source of the data file 108, an intended recipient of the fragment, etc.

Block 306 illustrates determining an available amount of bandwidth associated with a particular data transmission sent via a network. As described above, the transmission management module 220 can assess bandwidth associated with the network(s) 104. In some examples, the transmission management module 220 can determine how much bandwidth to allocate to a particular data transmission (which can be defined by resource block(s)). In such examples, the transmission management module 220 can analyze a location of a requesting device, a time associated with a request, data consumption associated with the device, etc. to determine how much bandwidth (e.g., how many resource block(s)) to allocate to the particular data transmission.

In at least one example, the transmission management module 220 can determine whether any bandwidth is unallocated for transmitting particular data transmissions. For instance, the transmission management module 220 can determine whether an amount of bandwidth allocated for a particular data transmission is completely consumed by that data transmission, or if any of the bandwidth is unallocated. In at least one example, the transmission management module 220 can determine an amount of bandwidth that is unallocated.

Block 308 illustrates determining whether the available amount of bandwidth is greater than or equal to a size of a fragment of the plurality of fragments. In at least one example, the transmission management module 220 can determine whether an amount of unallocated bandwidth associated with a particular data transmission is greater than or equal to the size of one or more of the fragments such to facilitate the transmission of one or more fragments associated with data file(s) in the data file queue 224. That is, in at least one example, the transmission management module 220 can determine whether the available amount of bandwidth associated with a particular data transmission is greater than or equal to a size of a fragment.

Based at least in part on the available amount of bandwidth being less than the size of the fragment, the transmission management module 220 can refrain from sending the fragment to the device 102 until the available amount of bandwidth is greater than or equal to the size of the fragment, as illustrated in block 310.

Based at least in part on the available amount of bandwidth being greater than or equal to the size of the fragment, the transmission management module 220 can send the fragment to the device 102, as illustrated in block 312. That is, responsive to determining that bandwidth is available and that the available bandwidth is greater than or equal to the size of the fragment, the transmission management module 220 can transmit the fragment via the network(s) 104, in association with the particular data transmission. In some examples, the transmission management module 220 can select one or more additional fragments that, in combination with the fragment, have a total size that is less than the amount of bandwidth available, and can transmit the one or more fragments via the network(s) 104, in association with the particular data transmission.

In at least one example, the transmission management module 220 can utilize metadata associated with headers of the fragments to determine which fragment(s) to send and when to send them. For instance, in at least one example, the transmission management module 220 can utilize metadata associated with headers of the fragments to prioritize which fragments to transmit and when to transmit such fragments. As an example, if a header indicates that a corresponding fragment is mandatory, the transmission management module 220 can transmit such a fragment prior to a fragment having a header that indicates that it is optional. In additional and/or alternative examples, in at least one example, the transmission management module 220 can utilize metadata associated with headers of the fragments to determine how to group fragments for transmission. For instance, in some examples, fragments associated with different data files can be transmitted together. As an example, the transmission management module 220 can group fragments together (from the same or different data files) for transmitting to a device so long as the fragments are being transmitted to the same recipient (e.g., the same requesting device, etc.).

Block 314 illustrates determining whether all of the plurality of fragments have been sent to the device. As described above, in at least one example, the data transmission status module 226 can track the progress of individual data transmissions. In at least one example, responsive to determining that the transmission management module 220 has sent at least one fragment of a data file in the data file queue 224, the data transmission status module 226 can remove the indicator of the data file from the data file queue 224 and can begin tracking the progress of the transmission of the data file. In at least one example, the data transmission status module 226 can indicate that transmission of the data file is in progress. As devices receive the fragments, the devices can send acknowledgement notifications back to the server(s) 100. The data transmission status module 226 can analyze received acknowledgement notifications, and update the status associated with the transmission of the data file. In at least one example, the data transmission status module 226 can analyze the progress of the transmission of the data file to determine whether each fragment of the plurality of fragments has been transmitted to the device 102.

In at least one example, the data transmission status module 226 can receive an acknowledgment notification associated with transmitting the fragment and can determine that one or more fragments of the plurality of fragments still need to be transmitted to the device 102. Based at least in part on determining that at least one fragment of the plurality of fragments has not been sent to the device 102, the transmission management module 220 can access another fragment of the plurality of fragments, as illustrated in block 316, and process 300 can return to block 306 to determine an available amount of bandwidth associated with a (different) particular data transmission that is to be sent via the network and whether there is enough bandwidth to transmit the other fragment to the device 102.

In at least one example, the data transmission status module 226 can receive an acknowledgment notification associated with transmitting the fragment and can determine that the fragment was the last fragment of the plurality of fragments that needed to be transmitted. Based at least in part on determining that all of the fragments have been sent to the device, the data transmission status module 226 can determine that the transmission of the data file is complete, as illustrated in block 318. Responsive to determining that the transmission of the data file is complete, the data transmission status module 226 can update the status of the transmission of the data file to indicate that the transmission is complete.

While FIG. 3 is directed to transmitting fragments of a data file in association with one or more real-time data transmissions, in additional and/or alternative examples, the one or more fragments associated with a data file can be transmitted at another time separate from a real-time data transmission. That is, in some examples, part of a data file can be transmitted in association with real-time data transmission(s) and part of a data file can be transmitted as its own transmission(s).

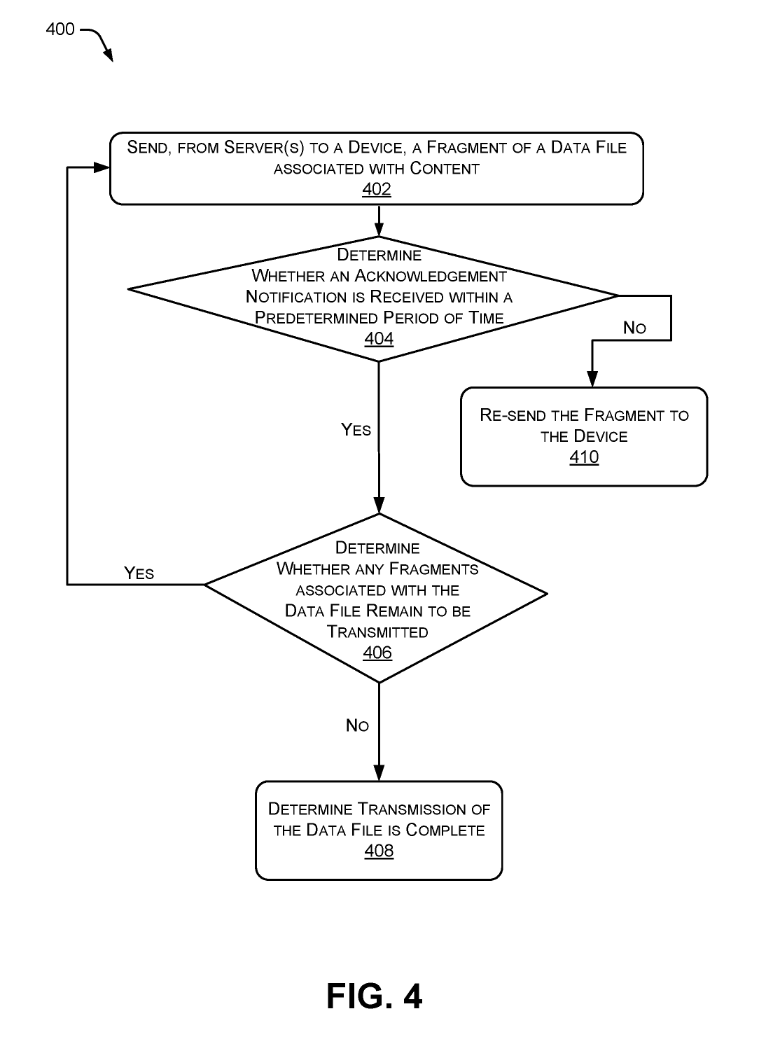

FIG. 4 illustrates an example process 400 for tracking progress of a fragmented data transmission.

Block 402 illustrates sending, from server(s) and to a device, a fragment of a data file associated with content. As described above, the data management module 218 can access data file(s) associated with content. In at least one example, the data management module 218 can receive a request for content and can access a data file associated with the content responsive to receiving the request. In other examples, the data management module 218 can access content without first receiving a request. In at least one example, the data management module 218 can retrieve the data file and can partition the data file into a plurality of fragments. As described above, each fragment can be associated with a size, which can be defined by a number of bits (or bytes). Fragments can have the same size or different sizes.

In at least one example, the transmission management module 220 can assess bandwidth associated with the network(s) 104. In some examples, the transmission management module 220 can determine how much bandwidth to allocate to a particular data transmission (which can be defined by resource block(s)). In such examples, the transmission management module 220 can analyze a location of a requesting device, a time associated with a request, data consumption associated with the device, etc. to determine how much bandwidth (e.g., how many resource block(s)) to allocate to the particular data transmission.

In at least one example, the transmission management module 220 can determine whether any bandwidth is unallocated for transmitting particular data transmissions. For instance, in at least one example, the transmission management module 220 can determine whether an amount of unallocated bandwidth associated with a particular data transmission is greater than or equal to the size of one or more of the fragments such to facilitate the transmission of one or more fragments associated with data file(s) in the data file queue 224. That is, in at least one example, the transmission management module 220 can determine whether the available amount of bandwidth associated with a particular data transmission is greater than or equal to a size of a fragment. Based at least in part on the available amount of bandwidth being greater than or equal to the size of the fragment, the transmission management module 220 can send the fragment to a device operated by a user. That is, responsive to determining that bandwidth is available and that the available bandwidth is greater than or equal to the size of the fragment, the transmission management module 220 can transmit the fragment via the network(s) 104, in association with the particular data transmission.

Block 404 illustrates determining whether an acknowledgment notification is received within a predetermined period of time. As described above, in at least one example, the data transmission status module 226 can track the progress of individual data transmissions. In at least one example, responsive to determining that the transmission management module 220 has sent at least one fragment of a data file in the data file queue 224, the data transmission status module 226 can remove the indicator of the data file from the data file queue 224 and can begin tracking the progress of the transmission of the data file. In at least one example, the data transmission status module 226 can indicate that transmission of the data file is in progress. As devices receive the fragments, the devices can send acknowledgement notifications back to the server(s) 100. The data transmission status module 226 can analyze received acknowledgement notifications, and update the status associated with the transmission of the data file. In at least one example, the transmission management module 220 can send a fragment and the data transmission status module 226 can track an amount of time that lapses before an acknowledgement notification is received. In such an example, the data transmission status module 226 can determine whether an acknowledgement notification is received within a predetermined period of time after sending the fragment.

Based on determining that an acknowledgment notification is received within the predetermined period of time, the transmission management module 220 can determine whether any fragments associated with the data file remain to be transmitted, as illustrated in block 406. In at least one example, the data transmission status module 226 can receive an acknowledgment notification associated with transmitting the fragment and can determine that one or more fragments of the plurality of fragments still need to be transmitted to the device 102. Based at least in part on determining that at least one fragment of the plurality of fragments has not been sent to the device 102, the transmission management module 220 can access another fragment of the plurality of fragments and process 400 can return to block 402 to send (another fragment) of the data file to the device 102.

Based at least in part on determining that no fragments associated with the data file remain to be transmitted, the data transmission status module 226 can determine that the transmission of the data file is complete, as illustrated in block 408. In at least one example, the data transmission status module 226 can receive an acknowledgment notification associated with transmitting the fragment and can determine that the fragment was the last fragment of the plurality of fragments that needed to be transmitted. Based at least in part on determining that all of the fragments have been sent to the device 102, the data transmission status module 226 can determine that the transmission of the data file is complete. Responsive to determining that the transmission of the data file is complete, the data transmission status module 226 can update the status of the transmission of the data file to indicate that the transmission is complete.

Based at least in part on determining that the acknowledgement notification is not received within the predetermined period of time, the transmission management module 220 can re-send the fragment to the device 102, as illustrated in block 410. Based at least in part on determining the lapse of a predetermined amount of time without receiving an acknowledgment notification, the data transmission status module 226 can determine that the transmission failed and can instruct the transmission management module 220 to re-send the fragment. In an additional and/or alternative example, the data transmission status module 226 can receive a request (e.g., from the device 102) to re-transmit a particular fragment and can instruct the transmission management module 220 to re-send the particular fragment responsive to receiving such a request. In such examples, the data transmission status module 226 can indicate that the transmission of the data file is incomplete and that the transmission management module 220 is re-transmitting at least a portion of the data file.

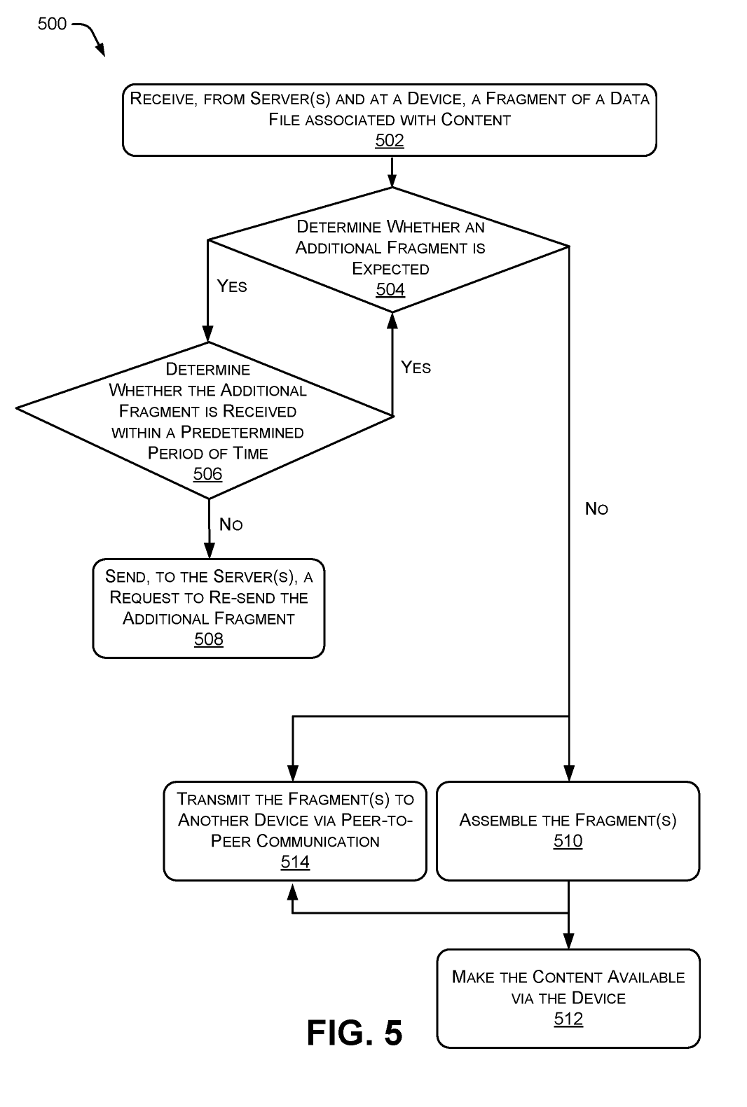

FIG. 5 illustrates an example process 500 for receiving fragmented data and assembling the fragmented data for making content available for consumption.

Block 502 illustrates receiving, from server(s) and at a device, a fragment of a data file associated with content. As described above, the content management module 210 can manage content for the device 102. In at least one example, the content management module 210 can receive a fragment of a data file associated with content at or near a same time as the content management module 210 receives another data transmission (e.g., a real-time data transmission, etc.). In at least one example, the content manager 210 can send a request for content (e.g., responsive to user input) to the server(s) 100. In such an example, responsive to sending the request for content, the content management module 210 can receive fragments of a data file associated with the requested content. In alternative examples, the content management module 210 can receive fragments of a data file without having first sent a request (e.g., content can be pushed to the device 102).

Block 504 illustrates determining whether an additional fragment is expected. As described above, in at least one example, a fragment can be associated with metadata (e.g., a header) that indicates that the fragment is a portion of a larger data file (which can signal that additional fragments are to be expected). In at least one example, the content management module 210 can analyze the fragment and associated metadata to determine whether to make content associated with the fragment available upon receipt, or to refrain from making the content available until additional fragments are received. That is, the content management module 210 can analyze the fragment and, based on determining a presence of a header indicating that the fragment is a portion of a larger data file, the content management module 210 can determine to refrain from making the content associated with the fragment available until additional fragments are received.

Based at least in part on determining that an additional fragment is expected, the content management module 210 can determine whether the additional fragment is received within a predetermined period of time, as illustrated in block 506. In at least one example, the content management module 210 can utilize a timer to track time. In at least one example, the content management module 210 can utilize the timer to determine whether an additional fragment is received within a predetermined period of time. Based at least in part on determining that the additional fragment is received within the predetermined period of time, process 500 can proceed to block 504, to determine whether another fragment is expected. If other fragments are expected, the other fragments can be delivered at subsequent time(s) in association with other data transmissions received by the device 102.

Based at least in part on determining that the additional fragment is not received within the predetermined period of time, the content management module 210 can send a request to re-send the additional fragment, as illustrated in block 508. That is, based on determining the lapse of a predetermined amount of time after the receipt of a fragment without receiving another fragment, the content management module 210 can send a request to the server(s) 100 to re-transmit a subsequent fragment.

Based at least in part on determining that an additional fragment is not expected, the content management module 210 can assemble the fragments, as illustrated in block 510. In at least one example, the content management module 210 can leverage a header associated with a fragment to determine whether a fragment is a last fragment of a plurality of fragments to be received. As described above, the header can indicate a position of a fragment relative to other fragments (e.g., a packet number) or a position of a fragment relative to a complete data file. In some examples, the content management module 210 can utilize headers associated with each of the received fragments to determine that all fragments have been received. After determining that all fragments associated with a data file have been received, the content management module 210 can assemble (e.g., reassemble) the multiple fragments to generate the complete data file at the device 102. That is, the content management module 210 can reconstruct the data file after all fragments associated with the data file have been received by the device 102.

Block 512 illustrates making the content available via the device. After the data file is assembled on the device 102, the content management module 210 can make the content associated with the data file available to the user. That is, the content management module 210 can enable the user to access the content for consumption.

In some examples, the device can share one or more fragments with another device via peer-to-peer communication. In such an example, based at least in part on determining that an additional fragment is not expected, the content management module 210 can share one or more fragments with the other device via peer-to-peer communication, as illustrated in block 514. In an alternative example, the content management module 210 can assemble the fragment(s) prior to sending the fragment(s) to the other device. That is, in such an example, the content management module 210 can transmit a complete data file to the other device.

Although the subject matter has been described in language specific to structural data items and/or methodological acts, it is to be understood that the subject matter defined in the appended claims is not necessarily limited to the specific data items or acts described. Rather, the specific data items and acts are disclosed as exemplary forms of implementing the claims.

What is claimed is:

1. A system comprising:
one or more servers associated with a service provider, the one or more servers including:
one or more first processors; and
one or more first computer-readable media storing first instructions executable by the one or more first processors, wherein the first instructions program the one or more first processors to:
access a data file associated with content;
partition the data file into two or more fragments, a first fragment of the two or more fragments associated with a first size and a second fragment of the two or more fragments associated with a second size;
determine an available amount of bandwidth associated with a data transmission to a first device operated by a first user via a network, the available amount of bandwidth comprising an amount of bandwidth that is not used by the data transmission;
determine that the available amount of bandwidth is greater than or equal to the first size;
send, via the network and at a first time associated with the data transmission, at least the first fragment of the two or more fragments to the first device; and
send, via the network and at a second time, the second fragment of the two or more fragments to the first device.

2. The system as claim 1 recites, wherein the first instructions program the one or more first processors further to determine that the available amount of bandwidth is greater than or equal to the first size and the second size, wherein the first time and the second time are a same time.

3. The system as claim 1 recites, wherein the first instructions program the one or more first processors to determine, at the second time, that the available amount of bandwidth is greater than or equal to the second size, wherein the first time and the second time are different times.

4. The system as claim 3 recites, wherein the second time is associated with another data transmission to the first device.

5. The system as claim 1 recites, wherein the first fragment corresponds to a beginning portion of the content and the second fragment corresponds to a subsequent portion of the content, and the first time is before the second time.

6. The system as claim 1 recites, wherein the first fragment corresponds to a beginning portion of the content and the second fragment corresponds to a subsequent portion of the content, and the first time is after the second time.

7. The system as claim 1 recites, further comprising a first application associated with the first device, the first application associated with one or more second computer-readable media storing second instructions executable by one or more second processors, wherein the second instructions program the one or more second processors to:
receive, in association with the data transmission, the first fragment;
receive the second fragment;
determine that the second fragment is a final fragment of the content;
assemble at least the first fragment and the second fragment to produce the content; and
enable the content to be accessible via the first device.

8. The system as claim 7 recites, wherein the second instructions program the one or more second processors further to transmit at least the first fragment and the second fragment to a second device operated by a second user via peer-to-peer communication.

9. A computer-implemented method performed by one or more servers of a service provider, the computer-implemented method comprising:
accessing a file associated with content;
partitioning the file into a plurality of fragments;
determining, at a time, an available amount of bandwidth associated with a data transmission to a device via a network;
determining that the available amount of bandwidth is greater than or equal to a first size of a fragment of the plurality of fragments;
sending, via the network and in association with the data transmission, at least the fragment of the plurality of fragments to the device; and
sending, via the network and at one or more other times, other fragments of the plurality of fragments to the device to enable the content to be available on the device.

10. The computer-implemented method as claim 9 recites, further comprising:
receiving, prior to accessing the file, a request for the content from the device; and
responsive to accessing the file, storing an indication of the file in a queue with indications of one or more other files that are waiting to be transmitted to one or more devices.

11. The computer-implemented method as claim 9 recites, further comprising:
tracking progress of a transmission of the plurality of fragments to the device;
receiving an acknowledgement notification indicating that at least one fragment of the plurality of fragments was received by the device;
determining, based at least in part on the acknowledgement notification, that each fragment of the plurality of fragments has been received by the device; and
determining that the transmission of the plurality of fragments is complete.

12. The computer-implemented method as claim 9 recites, further comprising:
tracking progress of a transmission of the plurality of fragments to the device;
determining a lapse in a predetermined period of time after sending the fragment and before an acknowledgment notification associated with the fragment is received;
determining, based at least in part on the lapse in the predetermined period of time, a failure of a transmission of at least the fragment; and
re-sending the fragment.

13. The computer-implemented method as claim 9 recites, further comprising:
receiving a request for re-transmission of at least one fragment of the plurality of fragments; and
re-sending the at least one fragment to the device.

14. The computer-implemented method as claim 9 recites, further comprising appending a header to the fragment to indicate that one or more additional fragments are needed to be received.

15. The computer-implemented method as claim 9 recites, further comprising appending a header to the fragment to indicate a characteristic of the content.

16. A computer-implemented method executed by a device operated by a user, the computer-implemented method comprising:
receiving, from one or more servers and at a first time, a first fragment of content in association with a data transmission of other content;
determining, based at least in part on a header associated with the first fragment, that one or more additional fragments are to be received prior to making the content available to the user;
receiving, from one or more servers and at a second time, at least a second fragment;
assemble the first fragment and at least the second fragment to produce the content; and
enable the user to access the content via the device.

17. The computer-implemented method as claim 16 recites, further comprising:
determining that the second fragment is a final fragment of the one or more additional fragments; and
assembling the first fragment and the one or more additional fragments to produce the content.

18. The computer-implemented method as claim 16 recites, further comprising:
determining a lapse in a predetermined period of time between receiving the first fragment and receiving an additional fragment of the one or more additional fragments; and
sending, based at least in part on the lapse in the predetermined period of time, a re-transmission request to the one or more servers.

19. The computer-implemented method as claim 16 recites, wherein the data transmission comprises a real-time data transmission.

20. The computer-implemented method as claim 16 recites, further comprising transmitting the content to another device operated by another user via peer-to-peer communication.
